(19) United States
(12) Patent Application Publication
(10) Pub. No.: US 2011/0186696 A1
(43) Pub. Date: Aug. 4, 2011

(54) CLIP AND SHIELD DEVICE USING THE SAME

(75) Inventors: KUN-CHIH HSIEH, Tu-Cheng (TW); JIAN-QIANG ZHAO, Shenzhen City (CN); JIAN ZENG, Shenzhen City (CN); XUE-FEI LENG, Shenzhen City (CN)

(73) Assignees: HONG FU JIN PRECISION INDUSTRY (SHENZHEN) CO., LTD., SHENZHEN CITY (CN); HON HAI PRECISION INDUSTRY CO., LTD., TU-CHENG (TW)

(21) Appl. No.: 12/871,847

(22) Filed: Aug. 30, 2010

(30) Foreign Application Priority Data
Feb. 2, 2010 (CN) 201010301099.0

(51) Int. Cl. F16L 3/12; F16B 2/20; F16L 3/08

(52) U.S. Cl. 248/74.2; 24/455; 24/530; 248/74.1

(57) ABSTRACT

A shield device includes a clip, which includes a base, two sidewalls and two clamping members. The two sidewalls extend upward from two opposite edges of the base, and the two clamping members extend upward and inward from the top of the sidewalls. The clamping members define a plurality of first clamping elements and a plurality of second clamping elements. Two opposite ones of the first clamping elements are spaced from each other at a first distance, two opposite ones of the second clamping elements are spaced from each other at a second distance, and the first distance is greater than the second distance.

### BACKGROUND

1. Technical Field

The present disclosure relates to clips and shield devices and, particularly, to a clip and a shield device using the same.

2. Description of Related Art

Electronic devices such as mobile phones usually include a plurality of electronic components, a plurality of cables soldered directly on the surface of a printed circuit board (PCB). Cables are difficult to handle, and there will be electromagnetic interference (EMI) or radio frequency interference (RFI) between the electronic components and the cables. In order to secure the cables and prevent EMI or RFI, the cables usually need to be grounded with a shield device. Although the conventional shield device satisfies the basic requirement, it is still desirable to provide a novel shield device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a shield device for securing a cable according to an exemplary embodiment.

FIG. 2 is an exploded view of the shield device of FIG. 1, showing a clip.

FIG. 3 is a side view of the clip of FIG. 2.

FIG. 4 is a schematic, isometric view of the clip according to a second embodiment.

FIG. 5 is a side view of the clip of FIG. 4.

### DETAILED DESCRIPTION

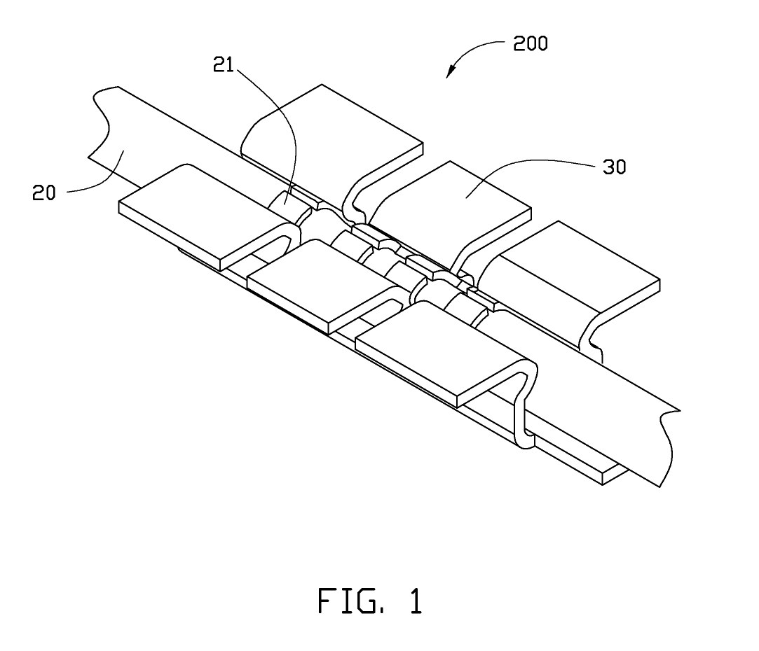

Referring to FIG. 1, a shield device 200 includes a retaining sleeve 21 and a clip 30. The retaining sleeve 21 is configured for securing a cable 20. The clip 30 is configured for securing the retaining sleeve 21.

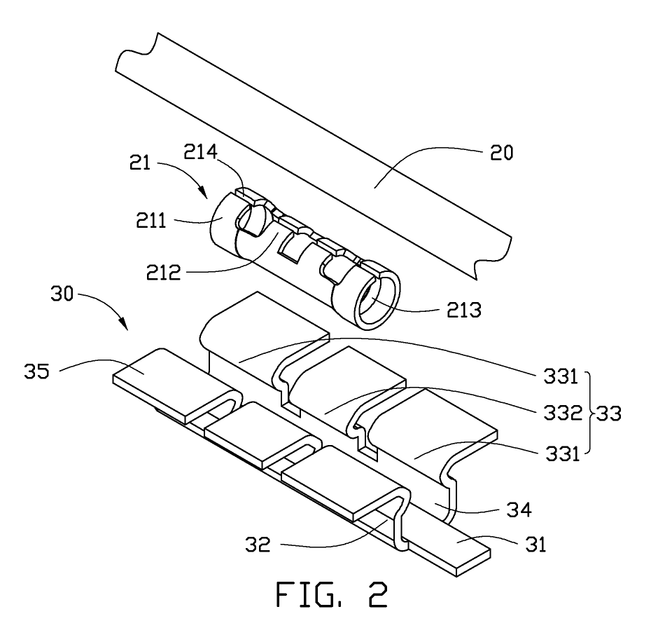

Referring to FIG. 2, the retaining sleeve 21 is made of elastic sheet metal, and defines a channel 213 sized and shaped to retain the cable 20. In the embodiment, the diameter of the channel 213 is set to be approximately the same as or slightly less than the diameter of the cable 20, so that the cable 20 can be tightly and securely retained in the channel 213. The retaining sleeve 21 defines a slot 214 along its lengthwise direction spanned from one end to an opposite end, allowing the retaining sleeve 21 to deform properly to tightly retain the cable 20.

The retaining sleeve 21 further includes a first sleeve member 211 in each end thereof, and a plurality of second sleeve members 212 between the first sleeve members 211. In the embodiment, the external diameter of the second sleeve members 212 is less than the external diameter of the first sleeve members 211. The cable 20 includes an external conductor (not shown) coated by an external sheath (not labeled) and a center conductor (not shown) covered by the external conductor. In the embodiment, numerable sections of the external sheath where the external sheath contacts with the retaining sleeve 21 are stripped, and the corresponding numerable sections of external conductor are thus exposed. In assembly, the first sleeve members 211 and the second members 212 contact the exposed sections of the external conductor, and the EMI or RFI on the cable 20 is thus transmitted to the retaining sleeve 21.

The clip 30 includes a base 31, two sidewalls 32, and two clamping members 33. Both sidewalls 32 extend upward from two opposite edges of the base 31, and are arranged at the same side of the base 31. Each clamping member 33 extends upward and inward from the top of the sidewall 32. The base 31, the sidewalls 32 and the clamping members 33 cooperate to define a channel 34 sized and shaped to retain the retaining sleeve 21. The clamping member 33 is substantially arc-shaped, and defines a plurality of first clamping elements 331 and a plurality of second clamping elements 332. The first clamping elements 331 are corresponding to the first sleeve members 211, and the second clamping elements 332 are corresponding to the second sleeve members 212.

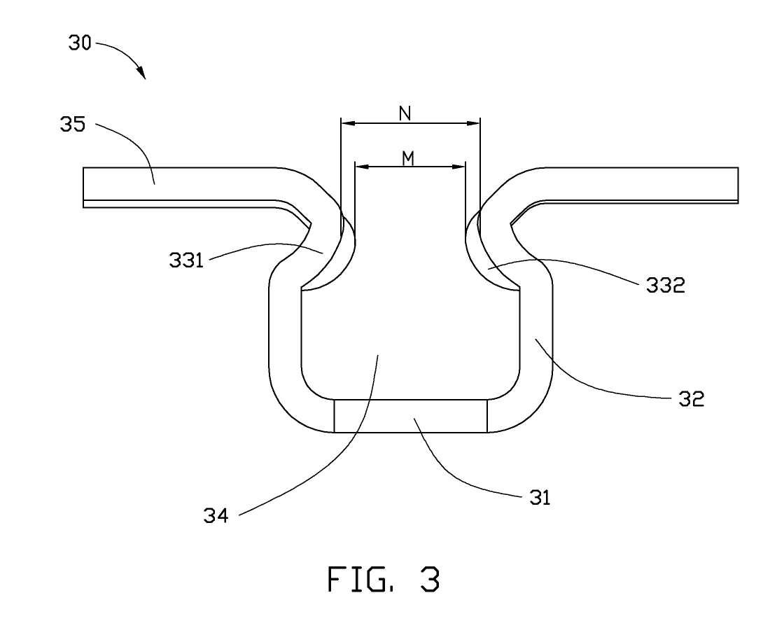

Referring also to FIG. 3, two opposite ones of the first clamping elements 331 are spaced from each other at a first distance N, two opposite ones of the second clamping elements 332 are spaced from each other at a second distance M. The distances N and M are less than the external diameter of the retaining sleeve 21. In the embodiment, the clip 30 is made of elastic material. The channel 34 thus has an open side through which the retaining sleeve 21 can be snap-fit.

In the embodiment, the first distance N is greater than the second distance M, thus the first clamping elements 331 can press firmly against the first sleeve members 221 from two opposite directions, and the second clamping elements 332 can press firmly against the second sleeve members 222 from two opposite directions. Thus, the retaining sleeve 21 is unmovable in the clip 30, and the shield device 200 can secure the cable 20.

The clip 30 further defines a plurality of flanges 35, which extend outward from the clamping member 33, in a direction substantially parallel to a circuit board (not shown) when the clip 30 is mounted on the surface of the circuit board. Thus, the flanges 35 mount to the surface of the circuit board, and the cable 20 is secured on the surface of the circuit board by the clip 30. The flanges 35 are electrical connected to the grounding of the circuit board, EMI or RFI can be reduced or even avoided.

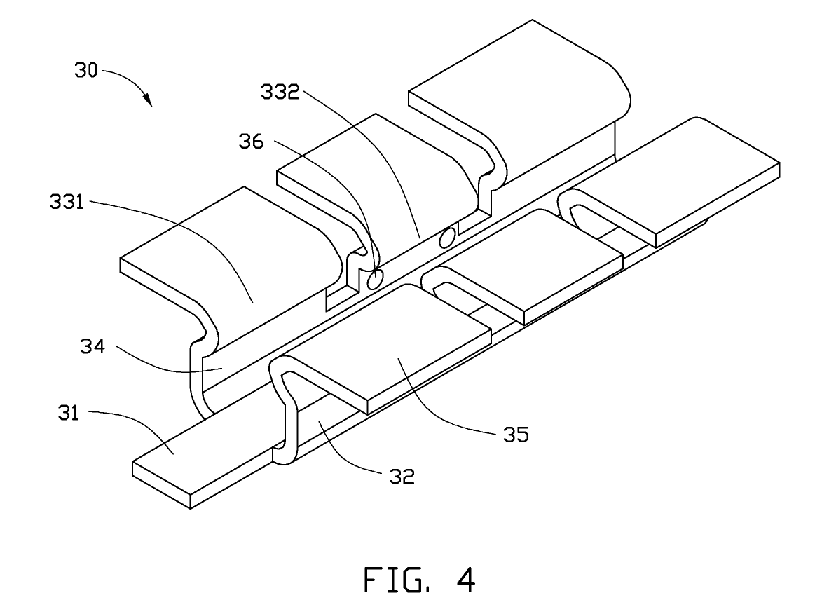

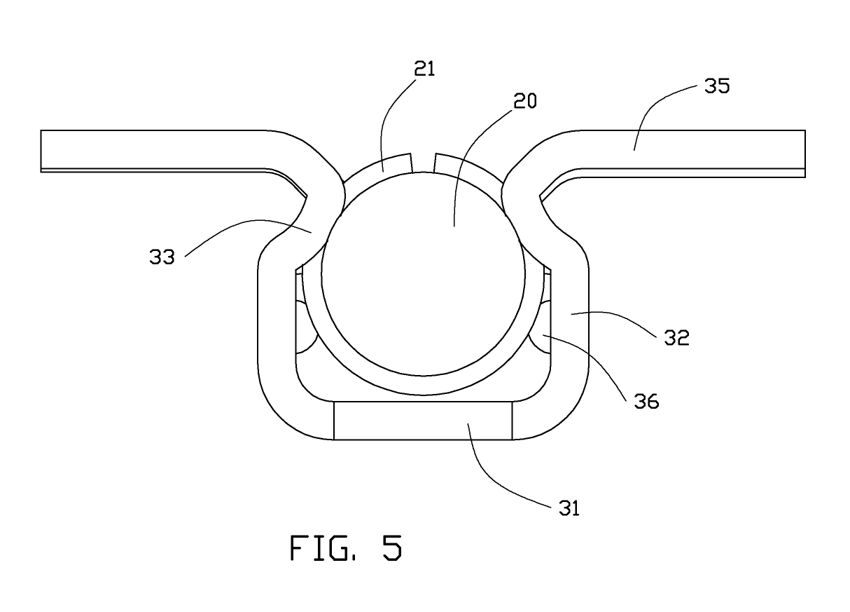

Referring to FIGS. 4 and 5, according to a second embodiment, a plurality of protrusions 36 protrude from the internal surfaces of the sidewalls 32, and are arranged under the second clamping elements 332. When the retaining sleeve 21 is snap-fit into the channel 34, the protrusions 36 press firmly against the second sleeve members 222 from two opposite directions, to secure the retaining sleeve 21 in the clip 30, the cable 20 is thus further secured.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A clip comprising:
a base;
two sidewalls extending upward from two opposite edges of the base; and
two clamping members extending upward and inward from the top of the sidewalls;
wherein, the clamping members define a plurality of first clamping elements and a plurality of second clamping elements;
two opposite ones of the first clamping elements are spaced from each other at a first distance, two opposite ones of the second clamping elements are spaced from each other at a second distance, the first distance is greater than the second distance.

2. The clip of claim 1, wherein each clamping member is arc-shaped.

3. The clip of claim 1, wherein the clip is made of elastic material.

4. The clip of claim 1, wherein the clip further defines a plurality of flanges extending outward from the clamping member and configured for mounting the clip to a circuit board.

5. The clip of claim 1, wherein a plurality of protrusions protrude from the internal surfaces of the sidewalls, which are arranged under the second clamping elements.

6. A shield device comprising:
a retaining sleeve configured for attaching and securing a cable, wherein the retaining sleeve defines a first sleeve member in each end thereof, and defines a plurality of second sleeve members in the middle thereof; and
a clip configured for securing the retaining sleeve, the clip comprising:
a base;
two sidewalls extending upward from two opposite edges of the base; and
two clamping members extending upward and inward from the top of the sidewalls;
wherein, the clamping members define a plurality of first clamping elements and a plurality of second clamping elements;
two opposite ones of the first clamping elements are spaced from each other at a first distance, two opposite ones of the second clamping elements are spaced from each other at a second distance, and the first distance is greater than the second distance;
the base, the sidewalls and the clamping members cooperate to define a first channel sized and shaped to retain the retaining sleeve.

7. The shield device of claim 6, wherein the first clamping elements are corresponding to the first sleeve members, and press firmly against the first sleeve members from two opposite directions; the second clamping elements are corresponding to the second sleeve members, and press firmly against the second sleeve members from two opposite directions.

8. The shield device of claim 6, wherein both the first distance and the second distance are less than an external diameter of the retaining sleeve.

9. The shield device of claim 6, wherein the first channel has an open side through which the retaining sleeve is snap-fit.

10. The shield device of claim 6, wherein the retaining sleeve is made of elastic sheet metal.

11. The shield device of claim 6, wherein the retaining sleeve defines a second channel sized and shaped to retain the cable.

12. The shield device of claim 11, wherein the retaining sleeve defines a slot along its lengthwise direction from one end to an opposite end, allowing the retaining sleeve to deform properly to tightly retain the cable.

13. The shield device of claim 11, wherein the diameter of the second channel is set to be approximately the same as or slightly less than the diameter of the cable.

14. The shield device of claim 6, wherein an external diameter of the second sleeve members is less than an external diameter of the first sleeve members.

15. The shield device of claim 6, wherein each clamping member is arc-shaped.

16. The shield device of claim 6, wherein the clip is made of elastic material.

17. The shield device of claim 6, wherein the clip further defines a plurality of flanges extending outward from the clamping member and configured for mounting the clip to a circuit board.

18. The shield device of claim 6, wherein a plurality of protrusions protrude from the internal surfaces of the sidewalls, which are arranged under the second clamping elements.

19. The shield device of claim 18, wherein the protrusions press firmly against the second sleeve members from two opposite directions when the retaining sleeve is snap-fit into the first channel.
